(19) United States
(12) Patent Application Publication
(10) Pub. No.: US 2010/0327009 A1
(43) Pub. Date: Dec. 30, 2010

(54) LIQUID DOSING APPARATUS

(76) Inventor: Paulus Antonius Augustinus Höfte, Astene (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/825,777

(22) Filed: Jun. 29, 2010

(30) Foreign Application Priority Data
Jun. 30, 2009 (EP) 09164099.5

(51) Int. Cl. B05B 11/04

(52) U.S. Cl. 222/1; 222/632; 222/325

(57) ABSTRACT

An apparatus and means to repeatedly dose a desired volume of liquid, comprising the removable cartridge comprising a first liquid, and the cartridge mating member.

### CROSS REFERENCE TO RELATED APPLICATION

This application claims priority under 35 U.S. C. §119(a) to European Application Serial No. 09164099.5, filed Jun. 30, 2009.

### FIELD OF THE INVENTION

The present invention relates to an apparatus and means of repeatedly dosing a desired volume of liquid.

### BACKGROUND TO THE INVENTION

There are instances when it is desirable to maintain components of a liquid composition separate from each other until just prior to the liquid composition being required. This could be for a number of reasons, including stability of the components or the desire for consumer in-house customization.

Oftentimes, the two or more liquids will be supplied separately in separate containers. The consumer can then dispense each liquid into a separate mixing receptacle in order to make the desired liquid composition just prior to use. EP1760142A1 discloses a number of ways of achieving late stage scent customization of laundry products. Many of these involve the consumer mixing at least two liquids in a receptacle prior to the resultant mixture being used in the intended application, such as a laundry machine. Thus, the consumer requires at least three separate articles in order to achieve the customization; the first liquid in a container, the second liquid in a container and the mixing receptacle. There are then a number of steps required to be completed by the consumer; pouring of the first liquid into the mixing receptacle, pouring of the second liquid into the mixing receptacle and dispensing of the resultant mixture from the mixing receptacle to the end use application. This process is time consuming and can result in spillage, unwanted skin contact or non-optimized volumes being used due to measuring inaccuracies. It also requires for efficient use, the consumer storing the three separate articles together which is space consuming.

WO 2006/11897 discloses a drinks container comprising a plurality of sealed additive chambers. The user presses these sealed chambers such that a seal is broken between them and the main chamber of the bottle, releasing the contents of the additive chamber into the main chamber, where it mixes with the contents of the main chamber. U.S. Pat. No. 6,165,523, U.S. Pat. No. 6,372,270, U.S. Pat. No. 6,705,490 and USRE038067 are all to containers comprising a first liquid and a cap to the container comprising a second liquid. The second liquid is kept separate from the first liquid by a seal. The user then presses a button or similar device incorporated into the cap which breaks the seal and releases the second liquid into the first liquid.

However, a problem with such devices is that the entire volume of the second liquid is added at once. Usually this is because once the seal to the removable article opening has been broken, the entire quantity flows into the receiving apparatus.

A solution to the above problem is to provide an article comprising multiple chambers and suitable measuring means, such as pump or trigger mechanisms or the like, so that a volume of a bulk liquid can be dispensed. WO 99/64319 and U.S. Pat. No. 7,481,334 are two devices comprising multiple chambers, where the contents of the two chambers can be dispensed simultaneously via the operation of pumps. The contents of the two chambers are then mixed upon exiting the device. However, such devices are complicated, involve many components, are expensive to manufacture, are bulky and do not allow the consumer to change the chambers.

U.S. Pat. No. 5,529,216 is to a spray bottle dispenser comprising the chemical reservoir for recharging the spray bottle dispenser. Some embodiments involve the refill being placed inside the bottle, therefore the refill gets contaminated and becomes messy to remove. U.S. Pat. No. 5,866,185 is to a dispensing device comprising a first liquid or other substance. The device is then placed into a second liquid and stirred. The contents of the device then mix with the second liquid. However, it is inconvenient and messy to remove the device as it will be contaminated both internally and externally with the mixture of the two liquids. This is not advantageous for applications such as in-house consumer customization as seen in EP1760142A1.

Another solution known in the art are multi-use removable cartridges like ink cartridges used in electronic printers. All these use an electrical signal and micro electronics to control the release of the product but this makes these too complex and too expensive for use in many applications.

There is a need in the art for an apparatus comprising a removable element able to store at least a first liquid, wherein at least once, a desired specific volume of the first liquid can be dispensed out of the apparatus, and preferably into a receiving unit.

There is a further need in the art for an apparatus that is clean to insert and remove without spillage or contamination of the content and that does not leak during use.

There is also a need in the art for the device to be small, compact, cheap to manufacture and involve few moving mechanical parts, and no electronic components.

There is a further need that this apparatus should not allow unintended activation when not being used.

### SUMMARY OF THE INVENTION

A first aspect of the present invention is an apparatus (1) for repeatedly dosing a desired volume of a liquid (5) comprising;

a removable cartridge (2) and a cartridge mating member (3);

wherein, the removable cartridge (2) comprises walls and an inner chamber (4), the inner chamber (4) comprising a liquid (5);

wherein, a first wall comprises a button (6), which upon being pressed will change shape and reduce the overall volume of the inner chamber (4), but upon release will return to its original shape, increasing the volume of the inner chamber (4) to its original volume;

and wherein, a second wall comprises a spring element (7), and a one-way valve (8), the second wall being positioned opposite the first wall;

wherein, the removable cartridge (2) is removably secured to the cartridge mating member (3) by means of a locking feature (12);

wherein the cartridge mating member (3) comprises, a one-way valve engagement pin (9), a spring element interaction surface (10), and an opening (11), such that when the removable cartridge (2) is removably secured to the cartridge mating member (3), the spring element (7) is in contact with the spring element interaction surface (10), the one-way valve (8) is positioned such that it is aligned with the one-way valve engagement pin (9), and the opening (11) is positioned such that the liquid (5) can flow into it from the inner chamber (4), upon engagement of the one-way valve (8) with the one-way valve engagement pin (9).

A second aspect of the present invention is a method for repeatedly dosing a desired volume of the liquid 5 using the apparatus 1 of any preceding claims, comprising the steps of;
pushing the button 6 so that it changes shape and reduces the overall volume of the inner chamber 4;
continuing to push the button 6 such that the removable cartridge 2 is moved closer to the cartridge mating member 3;
continuing to push the button 6 such that the spring element 7 is compressed against spring element engagement surface 10, and the one-way valve engagement pin 9 engages the one-way valve 8, opening it, and allowing the liquid 5 into the opening 11;
releasing the button 6, such that it returns to its original shape, and the spring element 7 is decompressed returning the removable cartridge 2 to its closed resting position;
wherein the locking feature 12 restricts the movement of the removable cartridge 2 away from the cartridge mating member 3.

### BRIEF DESCRIPTION OF THE DRAWINGS

FIG. 1 shows the apparatus 1 of the present invention, comprising a removable cartridge 2 and a cartridge mating member 3.

FIG. 2A-C shows the operation of the preferred locking feature 12 of the present invention, upon addition of the removable cartridge 2 to the removable cartridge mating member 3.

FIG. 3A-B shows the operation of a preferred one-way valve 8 of the present invention. The preferred valve comprising a sealing member 15 and a pin valve 16.

FIG. 4A-D shows the operation of another preferred one-way valve of the present invention. In this embodiment, the one-way valve is a flapper valve 17.

FIG. 5 shows one embodiment of the present invention in which the button 6 is manufactured as an integral part of the removable cartridge 2.

FIG. 6A-C shows the operation of the apparatus 1 to dose a volume of the liquid 5.

### DETAILED DESCRIPTION OF THE INVENTION

By the terms “a” and “an” when describing a particular element, we herein mean “at least one” of that particular element.

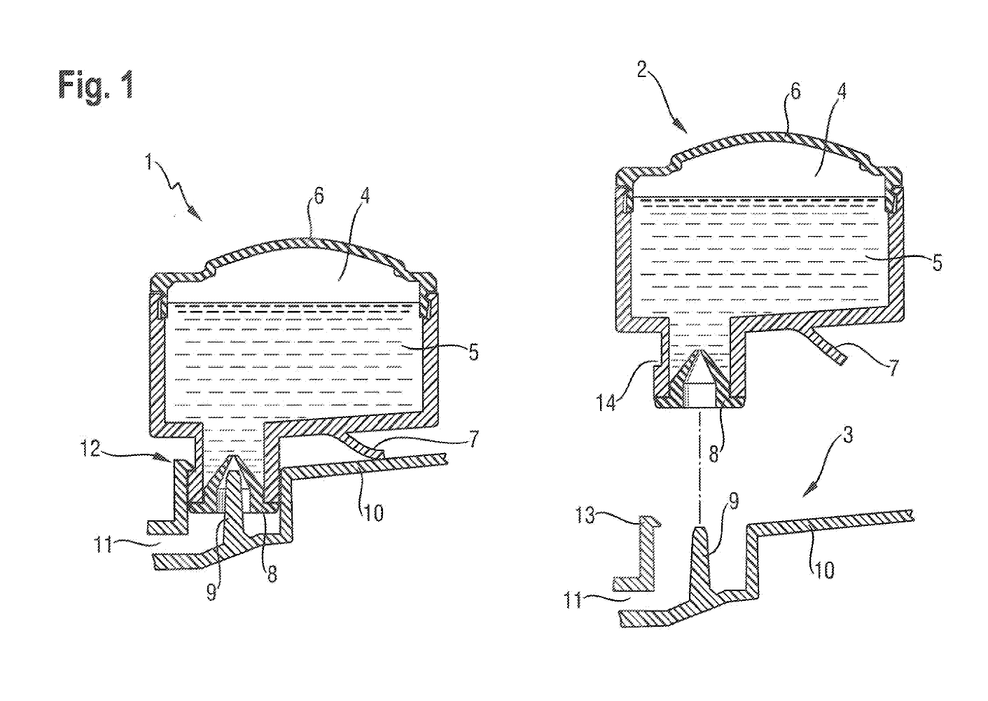

An embodiment of the present invention is shown in FIG. 1. The present is to an apparatus 1 for repeatedly dosing a desired volume of a liquid 5, comprising a removable cartridge 2 and a cartridge mating member 3. The removable cartridge 2 comprises walls and an inner chamber 4, the inner chamber 4 comprises a liquid 5. A first wall of the removable cartridge 2 comprises a button 6, which upon being pressed will change shape and reduce the overall volume of the inner chamber 4, but upon release will return to its original shape, increasing the volume of the inner chamber 4 to its original volume. A second wall comprises a spring element 7, and a one-way valve 8, the second wall being positioned opposite the first wall.

The removable cartridge 2 is removably secured to the cartridge mating member 3 by means of a locking feature 12. The cartridge mating member 3 comprises, a one-way valve engagement pin 9, a spring element interaction surface 10, and an opening 11, such that when the removable cartridge 2 is removably secured to the cartridge mating member 3, the spring element 7 is in contact with the spring element interaction surface 10, the one-way valve 8 is positioned such that it is aligned with the one-way valve engagement pin 9, and the opening 11 is positioned such that the liquid 5 can flow into it from the inner chamber 4, upon engagement of the one-way valve 8 with the one-way valve engagement pin 9.

In a preferred embodiment, the cartridge mating member 3 further comprises a wall, such as to form a housing for the removable cartridge 2. In another embodiment, the cartridge mating member 3 is integrated into a receiving unit, the receiving unit preferably selected from the group comprising, bottle, pouch, tube, container, receptacle, vessel, box, canister and the like. In a preferred embodiment, the cartridge mating member 3 is integrated into the receiving unit and also comprises a wall such as to form a cartridge housing integrated into the receiving unit.

The apparatus 1 comprises a locking feature 12 for removably securing the removable cartridge 2 to the cartridge mating member 3. This is necessary for the operation of the apparatus 1. When the removable cartridge 2 and the cartridge mating member 3 are removably secured, the spring element 7 is positioned to be in contact with the spring element interaction surface 10, the one-way valve 8 is positioned such that it is aligned with the one-way valve engagement pin 9, and the opening 11 is positioned such that the liquid 5 can flow into it from the inner chamber 4, upon engagement of the one-way valve 8 with the one-way engagement pin 9.

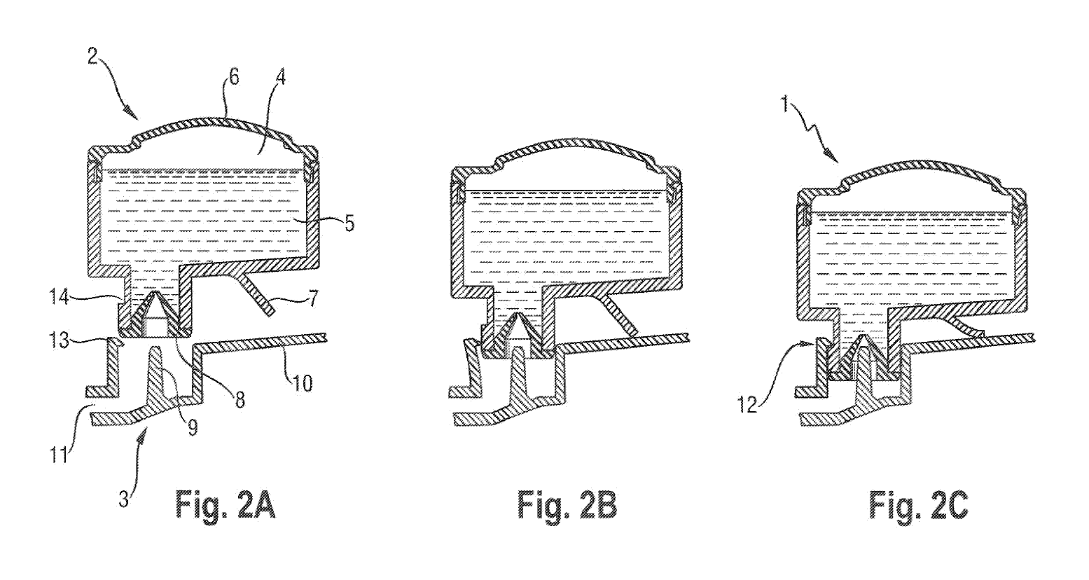

In one embodiment, the cartridge mating member 3 comprises a locking clip 13, and the removable cartridge 2 comprises a locking clip receptor 14. In another embodiment, the removable cartridge 2 comprises the locking clip, and the cartridge mating member 3 comprises a locking clip receptor. FIG. 2 details the operation of this preferred embodiment. The removable cartridge 2 is positioned to engage the cartridge mating member 3 as depicted in FIG. 2A. The removable cartridge 2 is then lowered onto the cartridge mating member 3, and the locking clip 13 is temporarily bent so as to accommodate the removable cartridge 2 as depicted in FIG. 2B. The removable cartridge 3 is then lowered further such that the locking clip 13 engages the locking clip receptor 14 so that the interaction between the locking clip and locking clip receptor 12 secures the removable cartridge 2 to the cartridge mating member 3 as depicted in FIG. 2C. The locking feature 12 is not limited to a clip and clip receptor arrangement. Those skilled in the art will recognize other suitable arrangements to removably secure the removable cartridge 2 to the cartridge mating member 3.

In a preferred embodiment, the securing feature 12 comprises a release mechanism to allow the user to release the securing feature 12 and so remove the removable cartridge 2 from the cartridge mating member 3. Those skilled in the art will recognize suitable mechanisms to achieve this. In a preferred embodiment the release mechanism comprises a flexible clip which is strong enough to hold the removable cartridge 2 in place during normal operation, preferably even when upside down, but which disengages by flexing away when the removable cartridge 2 is pulled out with a greater force, i.e. when the user pulls out the removable cartridge 2. In another embodiment the removable cartridge 2 can be released by manually tilting the removable cartridge 2 in its housing so that the clip 13 flexes away and disengages from the clip receptor 14. The removable cartridge 2 is then pushed away from the mating member 3 by the remaining tension in the spring element 7.

The removable cartridge 2 comprises the one-way valve 8. The one-way valve can be any suitable one-way valve, preferably selected from the group comprising, spring-loaded pin valve, spring loaded ball valve, flapper valve, overmolded flapper valve, duckbill valve, umbrella valve and combinations thereof. In a preferred embodiment the-way valve is a duckbill valve. The one-way valve 8 is positioned such that it can interact with the one-way valve engagement pin 9 of the cartridge mating member 3. In a further embodiment, the one-way valve 8 is positioned such that it can interact with at least two one-way valve engagement pins located on the cartridge mating member 3.

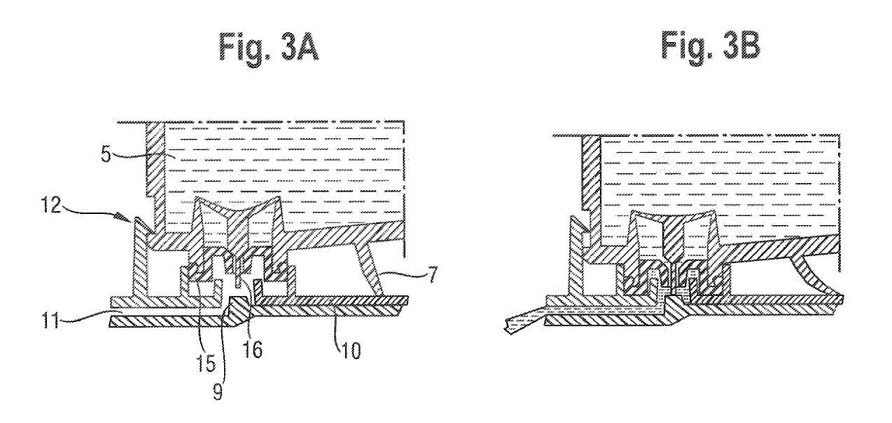

In a preferred embodiment the one-way valve is a spring loaded molded pin valve as shown in FIG. 3A which seals on a sealing member 15 and opens by pushing the pin valve 16 against the one-way valve engagement pin 9 of the cartridge mating member 3 (FIG. 3B).

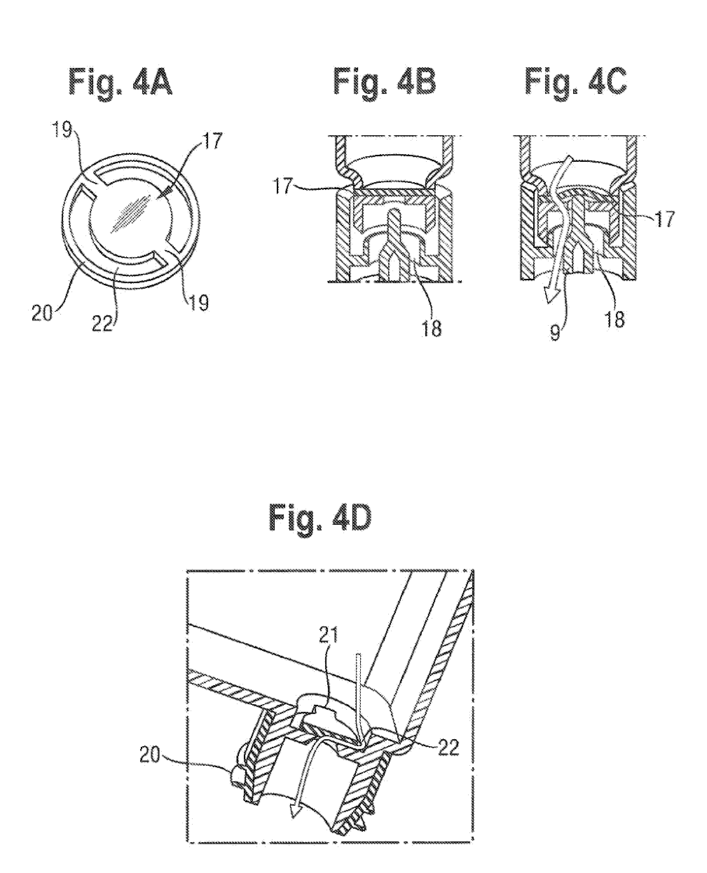

In another preferred embodiment the one-way valve 8 is a flapper valve 17 (FIG. 4A) which is overmolded on the removable cartridge exit opening 18 and which forms an additional sealing ring 20 around the neck of the removable cartridge exit opening (FIG. 4B). Those skilled in the art will recognize suitable shapes and forms for the sealing ring 20 (FIG. 4D). In one embodiment, the sealing ring 20 can comprise one or more sealing ribs. In a further embodiment, the sealing ring 20 may cover a part or the entire outside surface of the neck of the removable cartridge exit opening 18 so as to create a liquid tight seal with the cartridge mating member 3. When the flapper valve 17 is engaged with the one-way valve engagement pin 9, it is pushed upwards creating a gap 22 around and underneath the flapper valve 17. This allows the liquid 5 to flow through the gap 22 created around and underneath the flapper valve 17 and out of the removable cartridge 2, as shown in FIG. 4C. The flapper valve 17 (FIG. 4D) is mechanically connected through the wall of the cartridge exit opening 21 with the sealing ring 20 via at least two flexible bridges 19 of the same overmolded material that act as a spring element to keep the flapper valve 17 closed when not activated, but still allow it to be lifted up during activation with the one-way valve engagement pin 9. The at least two flexible bridges 19 then allow the flapper valve 17 to return to the closed position upon disengagement from the one-way valve engagement pin 9. The flapper valve 17 can be overmolded with any flexible material suitable for two-shot molding and which does not adhere to the material of the removable cartridge 2. Preferably, suitable materials for the flapper valve 17 can be selected from the group comprising soft grades of polyethylene, polypropylene, thermoplastic elastomers, thermoplastic urethane, liquid silicone rubbers, acrylonitrile butadiene rubber, nytril rubber, or natural rubbers or mixtures thereof. Those skilled in the art will recognize other suitable materials that can be used in the construction of the flapper valve.

The mating member 3 comprises the one-way valve engagement pin 9. By ‘one-way valve engagement pin’ we herein mean a projection of suitable dimensions and material to engage with and open the one-way valve 8 upon operation of the apparatus 1. The one-way valve engagement pin 9 should be of suitable dimensions such that upon engagement with the one-way valve 8, there is sufficient space for the first liquid 5 to flow from the inner chamber 4 into the outlet 11. In one embodiment, the one-way valve engagement pin 9 has a syringe configuration. In this embodiment, the one-way valve engagement pin 9 acts as a channel through which the first liquid 5 can flow through upon engagement of the one-way valve 8 with the one-way valve engagement pin 9.

The removable cartridge 2 comprises the spring element 7. The spring element 7 can be an integrated part of the removable cartridge 2 or could be a separate element manufactured of another material that is connected to the removable cartridge 2 using a suitable means, preferably selected from the group comprising mechanical, glued or welded. The spring element 7 can be made of any material which has elastic qualities, preferably selected from the group comprising spring metals, elastomeric plastics, natural or liquid silicon rubbers and the like, providing that upon being pressed or pulled, it returns to its former shape when released.

Suitable types of the spring element 7 are preferably selected from the group comprising coilsprings, blade springs, wire springs, leaf springs or combinations thereof.

In a preferred embodiment the spring element 7 is a leaf spring. In one embodiment, the spring element 7 is a leaf spring and is molded as an integrated part of the removable cartridge 2. In a preferred embodiment, the spring element 7 is a leaf spring and is made of polypropylene. The spring element 7 could also be incorporated into the cartridge mating member 3. In one embodiment, more than one spring element 7 is used.

A first wall of the removable cartridge 2 comprises a button 6, which upon being pressed will change shape and reduce the overall volume of the inner chamber 4, but upon release will return to its original shape, increasing the volume of the inner chamber 4 to its original volume. In a preferred embodiment, the button 6 is a mono-stable button which is known by those skilled in the art as any suitable actuator or recoverable collapsible element or assembly of elements, which can change shape between pressed configuration and an unpressed configuration by a substantially defined stroke. In other words, it can be pressed and so compress and expand between a defined starting position and a defined end position. This should be distinguished from squeezable containers where for example, the product chamber itself is squeezed by a greater or lesser degree to expel a variable quantity of product. In one embodiment, the button 6 may compress between a defined starting position and at least two defined end positions.

In one embodiment the button 6 may be of a ‘bellows’ configuration. The geometry and material composition of the button 6 should be such that upon compression of the button 6, the volume occupied within the button 6, preferably decreases by 50% or higher, most preferably by 70% or higher, between the expanded and compressed configuration. This ensures an efficient transfer of the actuation pressure applied to the button 6 into an increase in pressure in the inner chamber 4. Those skilled in the art will understand that this is most easily achieved if the button 6 collapses in the compression direction with minimal deformation in other directions. Suitable configurations for the button 6 of the present invention will be recognized by those skilled in the art to give reproducible, substantially constant dosing of the first liquid 5 during the complete dispensing of the product.

Dosing of the first liquid 5 occurs when the button 6 is pressed by the user, most likely using their finger, resulting in a reduction in the volume of the inner chamber 4. This displaced volume (displacement volume) translates into excess air pressure within the inner chamber 4 and acts to force out a specific volume of the first liquid 5 (dosage volume) through the one-way valve 8 once this is opened with the one-way valve engagement pin 9 on the cartridge mating member 3. The dosage volume is dependent upon the displacement volume, but is not equal to it due to the difference in compression dynamics between gases and liquids. However, each time the button 6 is pressed, it results in the same displacement volume translating into substantially the same amount of excess air pressure and hence substantially the same dosage volume, as seen in previous operations of the button 6. In other words the same dosage volume is achievable upon each use. The elastic properties of the button 6 forces the button 6 back into its starting position resulting in an expansion of the volume of the inner chamber 4 of the removable cartridge 2, which in turn creates a vacuum effect that sucks air back into the inner chamber 4 of the removable cartridge 2 via an air inlet. Preferably, the air inlet to the inner chamber 4 is in the form of the one-way valve 8.

The air inlet to the inner chamber 4 of the removable cartridge 2 can be provided in the form of the one-way valve 8. This allows air to enter the inner chamber 4 of the removable cartridge 2 when the internal pressure of the inner chamber 4 is lower than or equal to atmospheric pressure, but not escape when the internal pressure of the inner chamber 4 exceeds the atmospheric pressure during the compression of the button 6 by the user. In another embodiment, the air inlet may be provided on any other convenient part of the removable cartridge 2. In yet another embodiment, the button 6 may comprise the air inlet opening. In one embodiment, the air inlet opening may comprise a one-way valve. Preferably, it would be desirable for the air inlet opening comprising a one-way valve to quickly open when the minimal negative pressure differential is applied across it. More preferably, it would also be desirable for the air inlet opening comprising a one-way valve to remain open for a period of time sufficient to allow equalization of pressure to continue beyond the opening pressure differential after initially being opened. Preferably, the one-way valve of the air inlet opening comprising the one way valve is a conventional, flexible, resilient, low-pressure one-way valve preferably selected from the group comprising flap, umbrella, duck-bill, ball or disk valve. In another embodiment, the air inlet opening may be in the form of a vent incorporated into the button 6, that is covered by a user's finger or hand upon actuation and uncovered upon release.

In one embodiment, the removable cartridge 2 comprises two or more buttons 6. Each button may be a different size so that upon pressing them by the user, different displacement volumes are created. Therefore, different dosage volumes can be achieved depending upon which button is pressed by the user. In one embodiment, the removable cartridge 2 comprises two or more inner chambers 4. In this embodiment, one button 6 could be used to dose a volume of liquid from a first inner chamber and the second button could be used to dose a volume of liquid from the second inner chamber.

In another embodiment, the button 6 may contract between a defined starting position and at least two defined end positions. By varying the pressure exerted on the button 6, the user can compress the button 6 to either defined end position. One defined end position will result in a greater displacement volume than the other defined end position, allowing the user to dose a greater or smaller volume of the first liquid 5.

The button 6 may be formed of an inherently resilient material such as a deformable elastomeric material that is relatively more flexible than the rest of the removable cartridge 6 or the cartridge mating member 3, which may or may not also comprise a cartridge housing. Most preferably the button 6 should be formed with a material having positional memory. Preferably, suitable materials for the manufacture of the button 6 are selected from the group comprising polyethylene, polypropylene, polyoxymethylene plastic (available commercially as Delrin™), thermoplastic elastomer, liquid silicon rubber, thermoplastic urethane, acrylonitrile butadiene rubber, nytril rubber, natural rubber, ethylene propylene diene monomer rubber or similar materials or mixtures or copolymers of these materials.

In one embodiment, the button 6 is manufactured from a thermoplastic elastomer, preferably selected from the group comprising styrenic block copolymers, polyolefin blends, elastomeric alloys, thermoplastic polyurethanes, thermoplastic copolyester and thermoplastic polyamides or mixtures thereof. Preferred examples of commercially available thermoplastic elastomers include Santoprene™, poly(p-phenylene oxide), Elastolan™ and Hytrel™.

Preferably, the button 6 is manufactured from a material selected from the group comprising polyethylene, polypropylene or mixtures thereof. In one embodiment, the button 6 is manufactured from polyethylene. In another embodiment, the button 6 is manufactured from polypropylene.

The material may alternatively be flexible, but with the elastic return force provided by a spring element.

The button 6 can be industrially made via injection molding, extrusion, blowmolding, compression molding, thermoforming techniques and can be assembled with the rest of the removable cartridge elements via hot overmolding techniques or mechanically connecting these using specific snap features, glues, ultrasonic welding, heat-sealing, rotary welding or other techniques commonly known in the art.

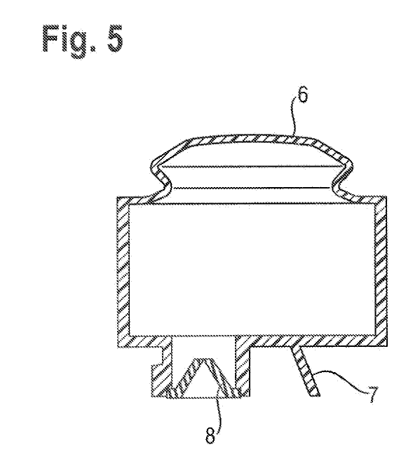

The button can also be made as an integral part of the removable cartridge 2 by using blowmolding techniques to form the entire cartridge as shown in FIG. 5. The body of the removable cartridge 2 and the button 6 are blowmolded from the same piece of material, and the one-way valve 8 is inserted separately.

The removable cartridge 2 preferably contains a volume of the first liquid 5 which is sufficient to allow for the dosage. The dosage volume is defined by the displacement volume under the button 6 which is displaced upon pressing the button 6. In a preferred embodiment, upon pressing the button 6, a dose between 0.01 ml and 50 ml is dispensed, more preferably between 0.5 ml and 20 ml is dispensed and even more preferably between 1 ml and 4 ml is dispensed.

The first liquid 5 may be any liquid. The term ‘liquid’ as used herein is not meant to be a limiting term and may encompass emulsions, dispersions, compositions, pastes, gels and the like or mixtures thereof.

The first liquid 5 is preferably an additive suitable for use in the group comprising fabric care, hair care and body, detergents/cleaners, dish care and the like.

Preferably, the additional liquid is selected from the group comprising perfume composition, encapsulated perfume composition, pro-perfume composition or combinations thereof. In a preferred embodiment, the additional liquid is a perfume composition

Preferably, the first liquid 5 is selected from the group comprising perfume composition, encapsulated perfume composition, pro-perfume composition or combinations thereof.

In a preferred embodiment, the first liquid 5 is a perfume composition.

In a preferred embodiment, the cartridge mating member 3 is integrated into a receiving unit. In a preferred embodiment, the cartridge mating member 3 is integrated into the receiving unit and also comprises sides such as to form a removable cartridge housing integrated into the receiving unit. In a preferred embodiment, at least one wall of the removable cartridge housing comprises one or more guiding ridges to aid the correct placement of the removable cartridge 2 onto the cartridge mating member 3. In such an embodiment, the removable cartridge 2 comprises one or more corresponding grooves positioned such that they correspond to the guide ridges when the removable cartridge 2 is placed into the removable cartridge housing to interact with the cartridge mating member 3.

The receiving unit is preferably selected from the group comprising, bottle, pouch, tube, container, receptacle, vessel, box, canister and the like. In a preferred embodiment, the receiving unit comprises a mixing reservoir into which the liquid 5 can be dispensed. In a more preferred embodiment, the receiving unit also comprises a chamber comprising a second liquid. Upon dispensing, the liquid 5 and the second liquid can mix in the mixing reservoir prior to use.

Preferably, the receiving unit comprises the cartridge mating member 3, more preferably, at least a first cartridge mating member and a second cartridge mating member, even more preferably at least a first cartridge mating member, a second cartridge mating member and a third cartridge mating member. In a most preferred embodiment, each cartridge mating member comprises at least a first wall so that each forms a housing integrated into the receiving unit for the removable cartridge 2. Each cartridge mating member can then interact with a removable cartridge 2.

In a most preferred embodiment, the receiving unit comprises a mixing reservoir and at least a first cartridge mating member, a second cartridge mating member and a third cartridge mating member. Each cartridge mating member can then interact with a removable cartridge such that the consumer can dose a volume of liquid from each removable cartridge into the mixing reservoir to make a mixture of at least 3 liquids.

### Method of Use

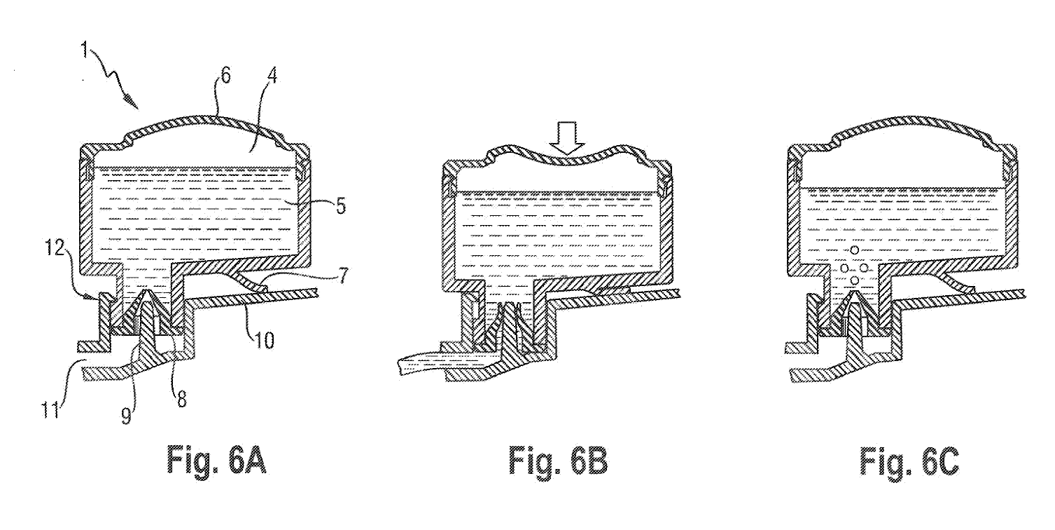

FIG. 6A-C depicts the operation of the apparatus 1. FIG. 6A depicts the resting position of the apparatus 1. The user presses the button 6 as depicted in FIG. 6B. This action change shape of the button 6, reduces the overall volume of the inner chamber (4) and pushes the cartridge 2 against the cartridge mating member 3. This compresses the spring element 7 against the spring element interaction surface 10, which brings the one-way valve 8 into contact with the one-way valve engagement pin 9, opening the one-way valve 8. The compression of the button 6 causes an overall decrease in the volume of the inner chamber 4 translating into excess air pressure within the inner chamber 4 and acts to force out a specific volume of the liquid 5 (dosage volume) through the one-way valve 8 once this is opened with the one-way valve engagement pin 9 on the cartridge mating member 3. The dosage volume of the liquid 5 can then flow from the inner chamber 4 through the opening 11 and preferably, into the receiving unit. As depicted in FIG. 6C, the user then releases the button 6, which also allows the decompression of the spring element 7. The elastic properties of the button 6 changes its shape back into its starting position resulting in an expansion of the volume of the inner chamber 4 of the removable cartridge 2, which in turn creates a vacuum effect that sucks air back into the inner chamber 4 of the removable cartridge 2 via an air inlet. Preferably, the air inlet to the inner chamber 4 is in the form of the one-way valve 8. The cartridge 2 is then pushed away from the cartridge mating member 3 by the spring element 7, but the movement is restricted by the securing feature 12. The one-way valve engagement pin 9 then disengages from the one-way valve 8 preventing any more of the first liquid 5 through the outlet 11.

In a further embodiment, at least two one-way valve engagement pins interact with the one-way valve 8 and open it so allowing the first liquid 5 to enter the outlet 11.

Preferably, the cartridge mating member 3 is integrated into a receiving unit. In this embodiment, the liquid 5 is dosed into the receiving unit. Preferably, the liquid 5 is dosed into an inner mixing chamber, wherein the liquid 5 and another liquid can be mixed within the receiving unit and then dispensed out of the receiving unit. In another embodiment, the liquid 5 is dosed in the receiving unit where it mixes directly with a second liquid and this mixture can be dispensed out of the receiving unit.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus for repeatedly dosing a desired volume of a liquid comprising;
a removable cartridge and a cartridge mating member;
wherein, the removable cartridge comprises walls and an inner chamber, the inner chamber comprising the liquid;
a first wall comprising a button, which upon being pressed will change shape and reduce the overall volume of the inner chamber, but upon release will return to its original shape, increasing the volume of the inner chamber to its original volume;
and wherein, a second wall comprises a spring element, and a one-way valve, the second wall being positioned opposite the first wall;
wherein, the removable cartridge is removably secured to the cartridge mating member by using a locking feature;
wherein the cartridge mating member comprises, a one-way valve engagement pin, a spring element interaction surface, and an opening, such that when the removable cartridge is removably secured to the cartridge mating member, the spring element is in contact with the spring element interaction surface, the one-way valve is positioned such that it is aligned with the one-way valve engagement pin, and the opening is positioned such that the liquid can flow into it from the inner chamber, upon engagement of the one-way valve with the one-way valve engagement pin.

2. The apparatus of claim 1, wherein the cartridge mating member is integrated into a receiving unit.

3. The apparatus of claim 1, wherein the cartridge mating member is integrated into a receiving unit and wherein the cartridge mating member comprises walls such as to form a cartridge housing integrated into the receiving member.

4. The apparatus of claim 3, wherein at least one wall comprises guiding ridges and the removable cartridge comprises corresponding guiding grooves.

5. The apparatus of claim 1, wherein the button is manufactured from a material selected from the group consisting of polyethylene, polypropylene, polyoxymethylene plastic, thermoplastic elastomer, liquid silicon rubber, thermoplastic urethane, acrylonitrile butadiene rubber, nytril rubber, natural rubber, ethylene propylene diene monomer rubber or similar materials and mixtures and/or copolymers thereof.

6. The apparatus of claim 1, wherein the one-way valve is selected from the group consisting of spring-loaded pin valve, spring loaded ball valve, flapper valve, overmolded flapper valve, duckbill valve, umbrella valve and combinations thereof.

7. The apparatus of claim 1, wherein the liquid is selected from the group consisting of a perfume composition, encapsulated perfume composition, pro-perfume composition and combinations thereof

8. The apparatus of claim 1, wherein the spring element is selected from the group comprising coilsprings, blade springs, wire springs, leaf springs or combinations thereof.

9. A method for repeatedly dosing a desired volume of the liquid using the apparatus of claim 1, comprising the steps of;
pushing the button so that it changes shape and reduces the overall volume of the inner chamber;
continuing to push the button such that the removable cartridge is moved closer to the cartridge mating member;
continuing to push the button such that the spring element is compressed against spring element engagement surface, and the one-way valve engagement pin engages the one-way valve, opening it, and allowing the liquid into the opening;
releasing the button, such that it returns to its original shape, and the spring element is decompressed returning the removable cartridge to its closed resting position;
wherein the locking feature restricts the movement of the removable cartridge away from the cartridge mating member.

10. The method of claim 9, wherein the liquid has a dose volume of between 0.01 ml and 50 ml.

11. The method of claim 10, wherein the liquid has a dose volume of between 1 ml and 50 ml.

12. The method of claim 9, wherein the cartridge mating member is integrated into a receiving unit, and the liquid is dosed into the receiving unit.

13. The method of claim 12 wherein, the receiving unit comprises a second liquid, and the liquid and the second liquid are mixed within the receiving unit and then dispensed out of the receiving unit.
